(19) United States
(12) Patent Application Publication
(10) Pub. No.: US 2020/0250970 A1
(43) Pub. Date: Aug. 6, 2020

(54) INFORMATION PROCESSING APPARATUS, INFORMATION PROCESSING METHOD AND PROGRAM

(71) Applicant: TOYOTA JIDOSHA KABUSHIKI KAISHA, Toyota-shi (JP)

(72) Inventors: Ayana TAKESHITA, Kasugai-shi (JP); Yoshihiro OHE, Kawasaki-shi (JP); Shunsuke TANIMORI, Susono-shi (JP); Ryosuke TANIMURA, Nisshin-shi (JP); Yuhei SUZUKI, Kariya-shi (JP); Hiromitsu FUJII, Kariya-shi (JP)

(73) Assignee: TOYOTA JIDOSHA KABUSHIKI KAISHA, Toyota-shi (JP)

(21) Appl. No.: 16/744,389

(22) Filed: Jan. 16, 2020

(30) Foreign Application Priority Data
Feb. 1, 2019 (JP) 2019-017366

(51) Int. Cl. G08G 1/017; G06K 9/00; G08G 1/01; B60R 11/04; G08G 1/054

(52) U.S. Cl. CPC G08G 1/0175; G06K 9/00771; G08G 1/054; B60R 11/04; G06K 9/00791; G08G 1/0133

(57) ABSTRACT

An information processing apparatus according to the present disclosure includes a storage unit configured to store traffic regulation information, which is information on traffic regulations, a control unit configured to determine, based on a video of the surroundings of a vehicle captured by an imaging unit provided in the vehicle and the traffic regulation information stored in the storage unit, whether a subject included in the video has made a traffic violation or not, and in a case where it is determined that the subject has made a traffic violation, identify the traffic violation made by the subject and a violation location at which the traffic violation has been made, and a communication unit configured to transmit the traffic violation and the violation location, identified by the control unit, to a database outside the vehicle.

### INCORPORATION BY REFERENCE

The disclosure of Japanese Patent Application No. 2019-017366 filed on Feb. 1, 2019 including the specification, drawings and abstract is incorporated herein by reference in its entirety.

### BACKGROUND

### 1. Technical Field

The present disclosure relates to an information processing apparatus, an information processing method, and a program.

### 2. Description of Related Art

A technology for acquiring information related to traffic violations from a video captured by a camera has been known. For example, Japanese Unexamined Patent Application Publication No. 2016-130935 discloses a technology for detecting a vehicle that has made a traffic violation based on a video captured by a camera provided at a specific location, such as an intersection.

### SUMMARY

In the related art, information on traffic violations made by, for example, a vehicle can be acquired only in the vicinity of a specific location where the camera is provided.

The present disclosure provides an information processing apparatus, an information processing method and a program, each of which is capable of acquiring information on the traffic violations in a wider area, considering the problem stated above.

An information processing apparatus according to an embodiment of the present disclosure is mounted on a vehicle including an imaging unit. The information processing apparatus includes a storage unit configured to store traffic regulation information, which is information on traffic regulations, a control unit configured to determine, based on a video of the surroundings of the vehicle captured by the imaging unit and the traffic regulation information stored in the storage unit, whether a subject included in the video has made a traffic violation or not, and in a case where it is determined that the subject has made the traffic violation, identify the traffic violation made by the subject and a violation location at which the traffic violation has been made, and a communication unit configured to transmit the traffic violation and the violation location, identified by the control unit, to a database outside the vehicle.

An information processing method according to an embodiment of the present disclosure is executed by an information processing apparatus mounted on a vehicle including an imaging unit. The information processing method includes a step of determining, based on a video of the surroundings of the vehicle captured by the imaging unit and traffic regulation information which is information on traffic regulations, whether a subject included in the video has made a traffic violation, in a case where it is determined that the subject has made the traffic violation or not, a step of identifying the traffic violation made by the subject and a violation location at which the traffic violation has been made, and a step of transmitting the identified traffic violation and the identified violation location to a database outside the vehicle.

A program according to an embodiment of the present disclosure causes an information processing apparatus mounted on a vehicle including an imaging unit to determine, based on a video of the surroundings of the vehicle captured by the imaging unit and traffic regulation information which is information on traffic regulations, whether a subject included in the video has made a traffic violation or not, in a case where it is determined that the subject has made the traffic violation, identify the traffic violation made by the subject and a violation location at which the traffic violation has been made, and transmit the identified traffic violation and the identified violation location to a database outside the vehicle.

With the foregoing aspects of the present disclosure, the information processing apparatus, the information processing method, and the program are capable of acquiring information on traffic violations in a wider area.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an exemplified configuration of an information processing system including an information processing apparatus according to an embodiment of the present disclosure;

FIG. 2 is a flowchart illustrating an exemplified operation of the information processing apparatus shown in FIG. 1; and

FIG. 3 is a sequence diagram illustrating an exemplified operation of the information processing system shown in FIG. 1.

### DETAILED DESCRIPTION OF EMBODIMENTS

Hereinafter, embodiments for implementing the present disclosure will be described in detail with reference to drawings. The same reference symbols indicate the same or equivalent components in each of the drawings.

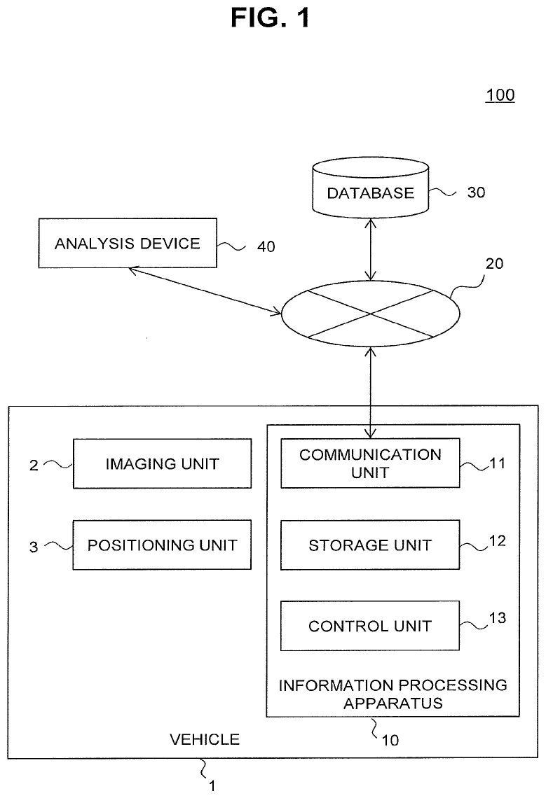

FIG. 1 is a diagram illustrating an exemplified configuration of an information processing system 100 including an information processing apparatus 10 according to an embodiment of the present disclosure. The information processing system 100 includes the information processing apparatus 10 mounted on a vehicle 1, a database 30, and an analysis device 40.

In a case where the information processing apparatus 10 according to the present embodiment detects a traffic violation made by a subject included in a video capturing the surroundings of the vehicle 1, the information processing apparatus 10 identifies the traffic violation made by the subject and a violation location at which the traffic violation has been made. Then, the information processing apparatus 10 transmits the identified traffic violation and the violation location at which the traffic violation has been made to the database 30 outside the vehicle 1 via a network 20 including a mobile communication network and the internet. Moreover, in FIG. 1, the single vehicle 1 is illustrated for the convenience of description, but the information processing apparatuses 10, respectively mounted on a plurality of vehicles 1, may transmit, to the database 30, the identified traffic violations and the violation locations at which the traffic violations have been made.

The database 30 stores information on the traffic violation and the violation location at which the traffic violation has been made, transmitted from the information processing apparatus 10. The database 30 can have any configuration as long as it has functions for performing communication via the network 20 and storing the information. Therefore, a detailed configuration of the database 30 is omitted.

The analysis device 40 carries out various processes by accessing the database 30 via the network 20 and analyzing the information stored in the database 30. The analysis device 40 is configured by, for example, one or more server devices connected to the network 20. The analysis device 40 can have any configuration as long as it has functions for communicating via the network 20, analyzing the information stored in the database 30 and carrying out various processes. Therefore, a detailed configuration of the analysis device 40 is omitted.

The database 30 and the analysis device 40 may be integrally configured.

Next, a schematic configuration of the vehicle 1 will be described.

The vehicle 1 includes an imaging unit 2, a positioning unit 3, and the information processing apparatus 10.

The imaging unit 2 includes an in-vehicle camera that generates a video by capturing a subject in the field of view. Furthermore, the in-vehicle camera may be a monocular camera or a stereo camera. The imaging unit 2 is provided in the vehicle 1 so as to capture the surroundings of the vehicle 1. For example, an electronic device having a camera function, such as a drive recorder and a smartphone used by an occupant may function as the imaging unit 2.

The positioning unit 3 includes a receiver corresponding to a satellite positioning system. The receiver is compatible with, but is not limited to, for example, the Global Positioning System (GPS), and may be compatible with any given satellite positioning system. For example, a car navigation device may function as the positioning unit 3. The positioning unit 3 acquires location information of the vehicle 1 on which the information processing apparatus 10 is mounted.

Next, a configuration of the information processing apparatus 10 will be described.

The information processing apparatus 10 illustrated in FIG. 1 includes a communication unit 11, a storage unit 12, and a control unit 13.

The communication unit 11 has a communication module connected to the network 20. The communication module is compatible with, but is not limited to, mobile communication standards, such as 4G (4th Generation) and 5G (5th Generation), and may be compatible with any given communication standard. For example, a data communication module (DCM) mounted on the vehicle 1 may function as the communication unit 11. In the present embodiment, the information processing apparatus 10 is connected to the network 20 via the communication unit 11.

The storage unit 12 includes one or more memories. The “memory” in the present embodiment is, for example, a semiconductor memory, a magnetic memory, or an optical memory, but is not limited thereto. Each memory included in the storage unit 12 may function as, for example, a main storage device, an auxiliary storage device, or a cache memory. The storage unit 12 stores any given information used in the operation of the information processing apparatus 10. For example, the storage unit 12 stores traffic regulation information, which is information on traffic regulations. Specifically, the storage unit 12 stores information on, for example, traffic regulations related to pedestrians crossing a crosswalk, traffic regulations related to traveling areas in which bicycles travels, and traffic regulations related to traffic signals and road signs. The storage unit 12 may store, for example, a system program, an application program, embedded software, and the like.

The control unit 13 is provided with one or more processors. The “processor” in the present embodiment is a general-purpose processor or a dedicated processor specialized for specific processing, but is not limited thereto. For example, an electronic control unit (ECU) mounted on the vehicle 1 may function as the control unit 13. The control unit 13 controls the overall operation of the information processing apparatus 10.

For example, the control unit 13 acquires a video of the surroundings of the vehicle 1 captured by the imaging unit 2. Based on the acquired video and the traffic regulation information stored in the storage unit 12, the control unit 13 determines whether the subject included in the video has made a traffic violation or not. The control unit 13 identifies, in a case where it is determined that the subject has made a traffic violation, the traffic violation made by the subject and a violation location which is a location at which the traffic violation has been made. Then, the control unit 13 allows the communication unit 11 to transmit the identified traffic violation and the violation location at which the traffic violation has been made to the database 30 via the network 20.

The operation of the information processing apparatus 10 according to the present embodiment will be described hereinbelow.

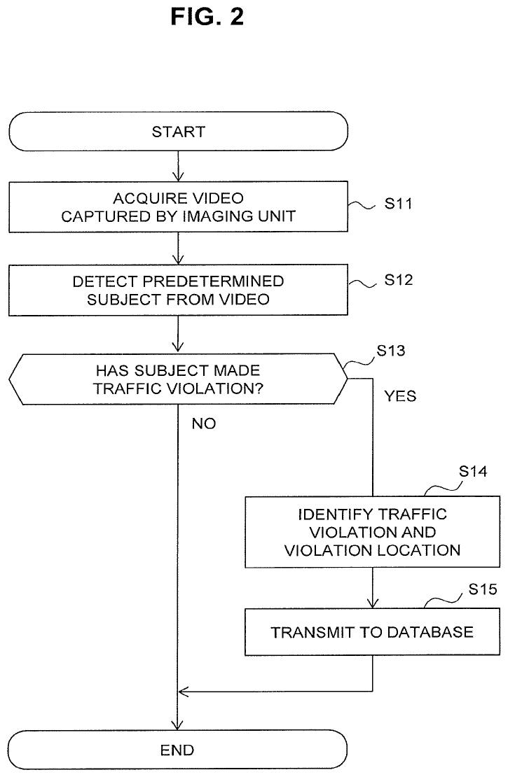

FIG. 2 is a diagram illustrating an exemplified operation of the information processing apparatus 10 according to the present embodiment, and is also a diagram illustrating the information processing method executed in the information processing apparatus 10. In FIG. 2, the operation of the control unit 13 will be mainly described.

The control unit 13 acquires the video captured by the imaging unit 2 (step S11).

Next, the control unit 13 detects a predetermined subject from the acquired video (step S12). For example, the control unit 13 detects, as the predetermined subjects, pedestrians, travelling bicycles, and other vehicles other than the vehicle 1 on which the information processing apparatus 10 is mounted. The detection of the predetermined subjects from the video captured by the imaging unit 2 can be carried out by, for example, various image recognition processes.

The control unit 13 determines, based on the traffic regulation information stored in the storage unit 12, whether the detected subject has made a traffic violation or not (step S13). For example, it is assumed that the subject is a pedestrian. In this case, the control unit 13 determines that in a case where, for example, a pedestrian detected as the subject crosses a road at a point near a crosswalk provided on the road but not the crosswalk itself, the pedestrian has made a traffic violation. In addition, the control unit 13 may determine whether a specific location is in the vicinity of the crosswalk or not, by comparing location information of the crosswalk stored in the storage unit 12 in advance and location information of the vehicle 1 measured by the positioning unit 3. Furthermore, the control unit 13 may determine that the specific location is in the vicinity of the crosswalk in a case where, for example, the video captured by the imaging unit 2 includes the crosswalk.

For example, it is assumed that the subject is another vehicle. In this case, the control unit 13 determines that, in a case where, for example, a vehicle detected as the subject ignores a traffic signal or does not pause, the vehicle has made a traffic violation.

For example, it is assumed that the subject is a bicycle. According to road traffic law, and the like, a traveling area where bicycle travels is determined in advance, such as the left side of the road. The control unit 13 determines that, in a case where a bicycle detected as the subject travels in an area which is not a predetermined traveling area, the bicycle has made a traffic violation.

The examples stated above are merely for description. The control unit 13 may determine whether or not a traffic violation has been made among various traffic violations that can be determined from the video captured by the imaging unit 2.

In addition, in a case where the control unit 13 can acquire identification information for identifying the target that has made a traffic violation from the video captured by the imaging unit 2, the identification information of the subject may be transmitted to the database 30 via the communication unit 11 and the network 20, in addition to the traffic violation that the subject has made and the violation location at which the traffic violation has been made. For example, in a case where the subject is a vehicle, the control unit 13 may acquire information on a license number as the identification information of the subject. Furthermore, for example, in a case where the subject is a pedestrian or a bicycle, the control unit 13 may acquire information on a face of the pedestrian or a face of a cyclist who rides the bicycle as the identification information of the subject. In this case, for example, the control unit 13 may assign identification information to each subject determined as the same pedestrian or cyclist.

If the control unit 13 determines that the subject has not violated the traffic regulation (step S13: NO), the control unit 13 ends the processing.

The control unit 13 identifies, in a case where it is determined that the subject has made a traffic violation (step S13: YES), the traffic violation made by the subject and a violation location at which the traffic violation has been made (step S14). For example, the control unit 13 identifies the location of the vehicle 1, measured by the positioning unit 3, at the time when the subject has made the traffic violation, as a violation location. Then, the control unit 13 allows the communication unit 11 to transmit the identified traffic violation and the violation location at which the traffic violation has been made to the database 30 via the network 20 (step S15), and ends the processing.

In the present embodiment, in a case where the information processing apparatus 10 determines that the subject included in the video captured by the imaging unit 2 provided in the vehicle 1 has made the traffic violation, the traffic violation and the violation location at which the traffic violation has been made are identified and stored in the database 30. Therefore, it is possible to acquire information on the traffic violation at various places where the vehicle 1 travels, that is, not only at a specific location where a camera is provided as in the related art, but also in a wider area.

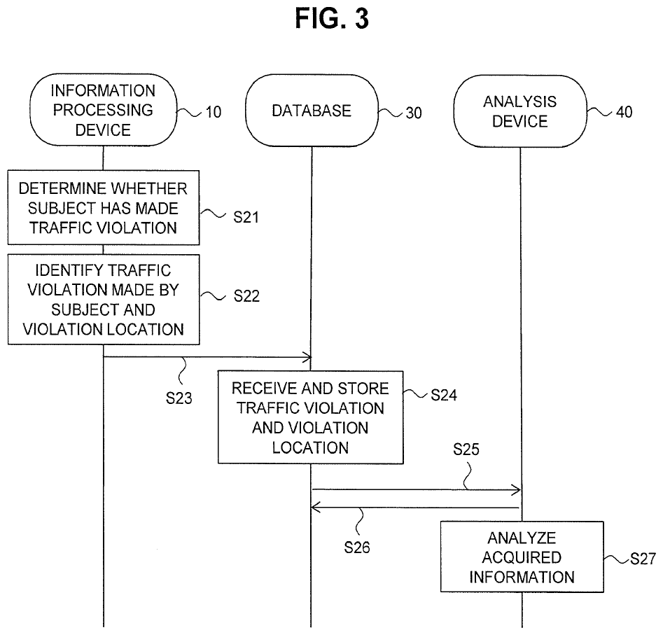

FIG. 3 is a sequence diagram illustrating an exemplified operation of the information processing system 100 shown in FIG. 1.

The information processing apparatus 10 determines whether the subject included in the video captured by the imaging unit 2 has made the traffic violation or not (step S21). In a case where it is determined that the subject has made the traffic violation, the information processing apparatus 10 identifies the traffic violation made by the subject and a violation location at which the traffic violation has been made (step S22). Then, the information processing apparatus 10 transmits the identified traffic violation and the violation location at which the traffic violation has been made to the database 30 (step S23).

The database 30 receives and stores information on the traffic violation and the violation location at which the traffic violation has been made, transmitted from the information processing apparatus 10 (step S24).

The analysis device 40 accesses the database 30 (step S25), and acquires information on the traffic violation and the violation location where the traffic violation has been made which are stored in the database 30 (step S26). Then, the analysis device 40 analyzes the acquired information (step S27) and carries out the various processes.

For example, the analysis device 40 may identify a location at which traffic violations have frequently been made, and may provide information, such as the identified location to predetermined authorities which are responsible for traffic infrastructure development or traffic control. Consequently, it is possible to promote the development of traffic infrastructure (crosswalks, footbridges, traffic signals, and the like) at locations where traffic violations are likely to occur, or to reduce traffic violations by traffic control.

For example, in a case where there are many pedestrians who cross the road at a location which is not a crosswalk, even though the crosswalk is provided on the road, it is possibly a case where the installation interval between the crosswalks is too wide. In such a case, traffic violations can be reduced by suggesting to the authorities a countermeasure, such as providing a new crosswalk on the road, and reducing the installation interval between the crosswalks. In addition, in a case where there are many vehicles that do not pause even though a stop sign is installed, it is possibly a case where it is difficult for vehicle drivers to recognize the sign. In such a case, traffic violations can be reduced by suggesting to the authorities a countermeasure, such as moving the signs to positions easily viewable by the vehicle drivers.

As stated above, the information processing apparatus 10 may transmit to the database 30 the identification information of the subject in addition to a traffic violation made by the subject and a violation location at which the traffic violation has been made. In this case, the analysis device 40 may determine whether the traffic violations at a specific violation location have been made by only a specific subject or an unspecified number of subjects. If the traffic violations at the specific violation location have been made only by the specific subject, it is considered that the problem is the specific subject not complying with the traffic regulations, not a defect of the traffic infrastructure. On the other hand, if the traffic violations at the specific violation location have been made by an unspecified number of subjects, it is considered that the traffic infrastructure is inadequate. Accordingly, it is possible to analyze the cause of the traffic violation more accurately and promote the development of appropriate traffic infrastructure by identifying and storing identification information of the subjects who have made traffic violations.

Moreover, in a case where the subject of the traffic violation is a child, the analysis device 40 may identify a school that the child attends, in order to notify the identified school of information on the traffic violation made by the subject and the violation location at which the traffic violation has been made. Consequently, the school can be urged to educate the child who has made the traffic violation so that the child can comply with the traffic regulations. The analysis device 40 can identify the school that the child attends from, for example, a school uniform of the child or a school emblem on a school bag held by the child.

In the present embodiment, the information processing apparatus 10, includes the storage unit 12 configured to store traffic regulation information, which is information on traffic regulations, a control unit 13 configured to determine, based on a video of the surroundings of the vehicle 1 captured by the imaging unit 2 and the traffic regulation information stored in the storage unit 12, whether a subject included in the video has made traffic violation or not, and in a case where it is determined that the subject has made the traffic violation, identify the traffic violation made by the subject and a violation location at which the traffic violation has been made, and the communication unit 11 configured to transmit the traffic violation and the violation location, identified by the control unit 13, to the database 30 outside the vehicle 1.

It is possible to acquire information on the traffic violation in a wider area in which the vehicle 1 travels, by identifying and transmitting to the database 30 the traffic violation made by the subject, included in the video captured by the imaging unit 2 provided in the vehicle 1, and the violation location at which the traffic violation has been made.

Although the information processing apparatus 10 has been described above, a computer can also be used to serve as the information processing apparatus 10. Such a computer is implemented by storing a program describing the processing content for implementing each function of the information processing apparatus 10 in a storage unit of the computer, and reading and executing the program by the CPU of the computer.

The program may be recorded on a computer-readable recording medium. The program can be installed on the computer using such a recording medium. The recording medium on which the program is recorded may be a non-transitory recording medium. The non-transitory recording medium is not particularly limited to, but may be, a recording medium, such as a CD-ROM or a DVD-ROM.

It will be apparent to those skilled in the art that the embodiments are merely representative examples, and various modifications or alterations can be made without departing from the scope of the present disclosure. Accordingly, the present disclosure should not be construed as being limited by the embodiments stated above, and various modifications and alterations can be made within the intent and scope of the claims. For example, it is possible to combine a plurality of configuration blocks described in the configuration diagram of the embodiment into a single block, or to divide a single configuration block into pieces.

What is claimed is:

1. An information processing apparatus mounted on a vehicle including an imaging unit, the information processing apparatus comprising:
a storage unit configured to store traffic regulation information, which is information on traffic regulations;
a control unit configured to determine, based on a video of surroundings of the vehicle captured by the imaging unit and the traffic regulation information stored in the storage unit, whether a subject included in the video has made a traffic violation or not, and in a case where it is determined that the subject has made the traffic violation, identify the traffic violation made by the subject and a violation location at which the traffic violation has been made; and
a communication unit configured to transmit the traffic violation and the violation location, identified by the control unit, to a database outside the vehicle.

2. The information processing apparatus according to claim 1, wherein:
the subject is a pedestrian; and
the control unit is configured to determine that, in a case where a pedestrian detected as the subject crosses a road at a point near a crosswalk provided on the road but not the crosswalk, the pedestrian has made a traffic violation.

3. The information processing apparatus according to claim 1, wherein:
the subject is a vehicle; and
the control unit is configured to determine that, in a case where a vehicle detected as the subject ignores a traffic signal or does not pause, the vehicle has made a traffic violation.

4. The information processing apparatus according to claim 1, wherein:
the subject is a bicycle; and
the control unit is configured to determine that, in a case where a bicycle detected as the subject travels in an area which is not a predetermined traveling area, the bicycle has made a traffic violation.

5. The information processing apparatus according to claim 1, wherein:
the control unit is configured to acquire identification information for identifying the subject that has made the traffic violation from the video captured by the imaging unit; and
the communication unit is configured to transmit, to the database, the identification information acquired by the control unit, in addition to the traffic violation made by the subject and the violation location at which the traffic violation has been made.

6. An information processing method executed by an information processing apparatus mounted on a vehicle including an imaging unit, the information processing method comprising:
determining, based on a video of surroundings of the vehicle captured by the imaging unit and traffic regulation information which is information on traffic regulations, whether a subject included in the video has made a traffic violation or not;
in a case where it is determined that the subject has made the traffic violation, identifying the traffic violation made by the subject and a violation location at which the traffic violation has been made; and
transmitting the identified traffic violation and the identified violation location to a database outside the vehicle.

7. A program, the program causing an information processing apparatus mounted on a vehicle including an imaging unit to execute:
determining, based on a video of surroundings of the vehicle captured by the imaging unit and traffic regulation information which is information on traffic regulations, whether a subject included in the video has made a traffic violation or not;
in a case where it is determined that the subject has made the traffic violation, identifying the traffic violation made by the subject and a violation location at which the traffic violation has been made; and
transmitting the identified traffic violation and the identified violation location to a database outside the vehicle.
